(19) United States
(12) Patent Application Publication
(10) Pub. No.: US 2011/0163888 A1
(43) Pub. Date: Jul. 7, 2011

(54) METHOD AND SYSTEM FOR PROVIDING DIAGNOSTIC INFORMATION REGARDING A COMMERCIAL TELEVISION

(75) Inventor: Kirby Goedde, Morristown, IN (US)

(73) Assignee: SHENZHEN TCL NEW TECHNOLOGY LTD., Shekou, Shenzhen, Guangdong (CN)

(21) Appl. No.: 13/063,147

(22) PCT Filed: Dec. 15, 2008
(86) PCT No.: PCT/US2008/086840

§ 371 Date: Mar. 9, 2011

(30) Foreign Application Priority Data
Sep. 25, 2008 (CN) 200810161438.2

(51) Int. Cl. G09F 9/33

(52) U.S. Cl. 340/815.45

(57) ABSTRACT

Systems, apparatus, and methods relating to facilitating diagnosis of issues with commercial televisions are provided. For example, embodiments are directed to a commercial television including an interface configured to facilitate communication between the commercial television and an auxiliary device, and an indicator configured to coordinate with the interface and provide a visual indication of a status of the interface.

### BACKGROUND

This section is intended to introduce the reader to various aspects of art which may be related to various aspects of the present techniques that are described below. This discussion is believed to be helpful in providing the reader with background information to facilitate a better understanding of the various aspects of the present techniques. Accordingly, it should be understood that these statements are to be read in this light, and not as admissions of prior art.

A commercial television may be defined as a television that has been specifically designed to be cost effective and used in commercial markets. For example, a commercial television may be designed for use in a hotel, a hospital, a prison, an airport, or the like. Commercial televisions may include features that facilitate cost effective systems to be designed and installed. For example, RCA® commercial televisions may include a digital serial communications interface (DSCI) port that may facilitate inclusion of networked control and monitoring features for televisions that preferably do not include high per-room or head-end costs.

A DSCI port may be used by various third-parties, such as pay per view (PPV) vendors and hospital television rental operations, to control particular televisions in a commercial setting. The third-parties that typically interface with commercial televisions may design and produce specialized devices, such as programming tools, for use with the commercial televisions. For example, many third-parties design applications or products based on the specifications for the DSCI port. Different third parties and different applications may utilize the DSCI port in different ways. In other words, each third-party vendor and/or application may implement their system in a different way. There are typically a large number of different third-parties and different features. Accordingly, there are typically a large number of operational distinctions between systems.

### BRIEF DESCRIPTION OF THE DRAWINGS

In the drawings:

FIG. 1 is a perspective drawing of a commercial television communicatively coupled with an auxiliary device in accordance with an embodiment of the present techniques;

FIG. 2 is a block diagram of an electronic device communicatively coupled with an auxiliary device in accordance with an embodiment of the present techniques;

FIG. 3 is a perspective view of a DSCI port with a plurality of status indicators in accordance with an embodiment of the present techniques; and

FIG. 4 is a process flow diagram of a method in accordance with an embodiment of the present techniques.

### DETAILED DESCRIPTION OF THE PREFERRED EMBODIMENT

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Present embodiments are directed to a commercial television that includes a self-diagnosing interface port, such as a DSCI port, a pay per view port, or a smart port. The interface port may include an eight-pin RJ45 Ethernet port or a six-pin RJ25 port that facilitates transfer of information between the commercial television and other devices. Third-parties may utilize the interface port to control and interact with the commercial television. Further, third-parties may utilize the interface port to develop their products. Such third-parties may include PPV vendors, other television related service providers, programming tools, and so forth. Indeed, numerous third-parties may utilize the interface port during normal operation and/or develop products using the interface port. Each such third-party may implement their system in a different way. It is now recognized that this diversity of implementations can cause difficulty in determining where a malfunction is originating. In other words, when issues arise regarding the function of the commercial television with third-party devices and/or designs, it can be difficult to determine what is causing the issues.

Exemplary issues that may arise with the functionality of a commercial television and third-party equipment may include faulty and/or improperly designed third party hardware. When such faulty and/or improperly designed hardware is coupled with a commercial television and it does not work, the third-party or some other party may contact the commercial television provider and assert that the commercial television is the issue. The troubleshooting that follows can waste the commercial television provider's time. In other instances, the commercial television may actually be faulty, but the troubleshooter may still have to diagnose the third-party's hardware to confirm that the problem is initiating with the television, which wastes time and creates extra expense. In another example, a party experiencing difficulty with the commercial television may improperly determine that fault lies with the interface port and request a replacement television because the interface port is not functioning, while, in actuality, the commercial television is merely set up improperly.

Present embodiments facilitate determining whether the commercial television or the third-party's services and/or equipment are causing an issue. Specifically, present embodiments are directed to an interface port that includes diagnostic indicators, such as light emitting diodes (LEDs), to provide status indications with respect to the functionality of the interface port and the commercial television. Present embodiments may facilitate troubleshooting with respect to whether the commercial television and/or auxiliary equipment or software has an operational issue, such as an improper setup. Thus, present embodiments may prevent third-parties from burdening the commercial television provider with issues that are not originating from the commercial television. Similarly, present embodiments may facilitate diagnosis of issues present with the television. This may save commercial television providers and service providers significant time and expense in responding to requests for technical support.

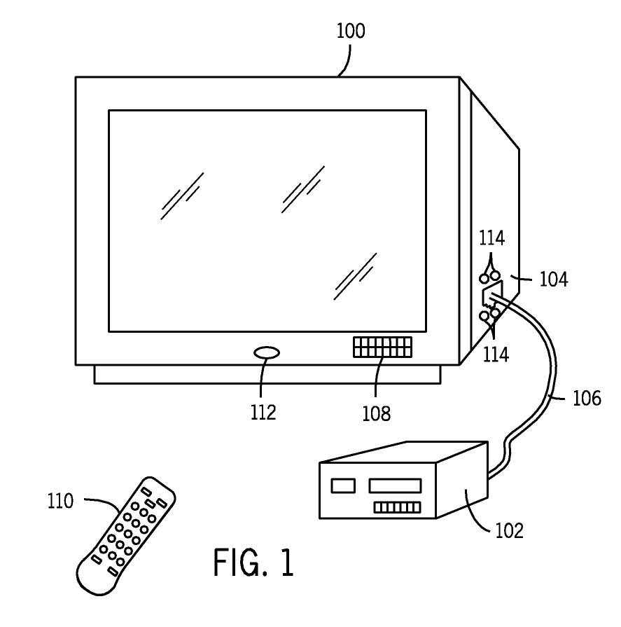

FIG. 1 is a perspective view of a commercial television 100 that may be communicatively connected to an auxiliary device 102. In the embodiment shown in FIG. 1, the auxiliary device 102 may include any of various different devices. For example, one of ordinary skill in the art will recognize that the auxiliary device 102 may include a television programming supply box, a PPV service box, a television programming tool, a digital video recorder and/or player, a computer, a CD player, or the like. The commercial television 100 may have an interface 104, such as a DSCI port, which may communicatively couple to a cable 106 from the auxiliary device 102. In an embodiment, this cable 106 may be configured to carry control signals between the commercial television 100 and the auxiliary device 102. When the auxiliary device 102 is coupled with the interface 104, communications may be established when the auxiliary device 102 answers a poll from the commercial television 100. It should be noted that audio and video signals for the commercial television 100 may be carried by a separate cable (e.g., a coaxial cable).

Certain functions of the commercial television 100 may be controlled by a limited set of buttons on a front panel 108, including, for example, a power switch, channel buttons, and volume buttons. Additionally, the commercial television 100 may be controlled by a remote control 110. Signals from the remote control 110 may be received by the commercial television 100 through a remote receiver 112, which may be located on the front of the commercial television 100. In some embodiments, the remote receiver 112 may be a photodetector for receiving encoded light pulses. In other embodiments, the remote receiver 112 may be an antenna for receiving radio signals.

One function of the commercial television 100 may be to supply media or perform actions indicated by the auxiliary device 102 and transmitted from the auxiliary device 102 to the commercial television 100 via the interface 104. The interface 104 may receive IR from a remote control and output the IR to the commercial television to facilitate external device access to controls of the commercial television. When the commercial television receives a message from an external device via the interface 104, the commercial television may respond with actions in accordance with the message. For example, the message may include digital instructions from an external device that relate to certain television controls, such as power, channel, volume, and so forth. Further, the interface 104 may include a plurality of indicators 114, such as LEDs, that are adapted to provide information regarding the functionality of the interface 104. Such information may facilitate the provision of technical support for the commercial television 100 and/or the auxiliary device 102.

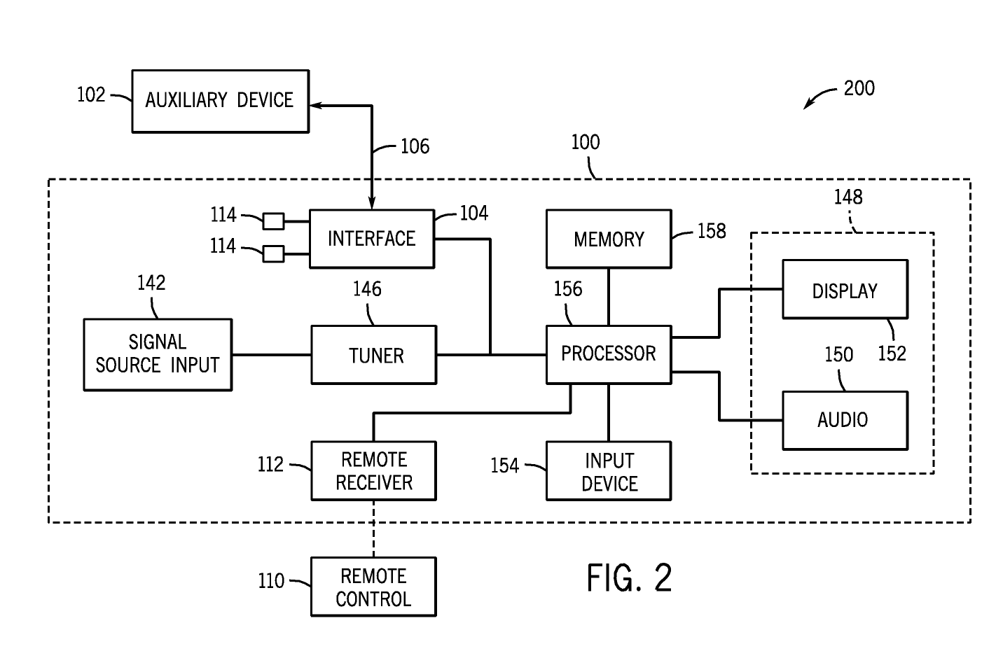

FIG. 2 is a block diagram of a commercial television system 200 in accordance with an embodiment. In the illustrated embodiment, the system 200 includes the commercial television 100 and the auxiliary device 102 of FIG. 1. The commercial television 100 includes various subsystems represented as functional blocks in FIG. 1. One of ordinary skill in the art will appreciate that the various functional blocks shown in FIG. 1 may include hardware elements (including circuitry), software elements (including computer code stored on a machine-readable medium, such as a memory) or a combination of both hardware and software elements.

The commercial television 100 may have a signal source input 142, which may include an antenna input, an audio input, a video input, an S-video input, a composite video input, a digital video input, or combinations thereof. One of ordinary skill in the art will appreciate that, although only one signal source input 142 is shown, the electronic device 100 may have multiple signal source inputs. The signal source input 142 may be adapted to receive a signal that comprises video signals and/or audio signals. As will be appreciated, the signal received by the signal source input 142 may comprise a broadcast spectrum or a single channel of video and/or audio signal.

A tuner subsystem 146 may be adapted to tune a particular video program from a broadcast signal received from the signal source input 142. One of ordinary skill in the art will appreciate that input signals that are not received as part of a broadcast spectrum may bypass the tuner subsystem 146 because tuning is not required to isolate a video program associated with those signals.

The interface 104 may be utilized as a control input to the electronic device 100. The interface 104 may include, for example, a DSCI port that allows the commercial television 100 to communicate with an external unit, such as the auxiliary device 102. As discussed below, the interface 104 may be used for the transfer of control information between the electronic device 100 and the auxiliary device 102. For example, the interface 104 may transmit commands, such as instructions to purchase a movie, from the commercial television 100 to the auxiliary device 102. The signal source input 142 may facilitate transmission of media, such as digital media signals for presentation via the commercial television 100. These media signals may comprise digital still pictures, audio signals, or video signals, or any combination thereof, and the media files may be continuously transferred, or streamed during play by the commercial television 100. In some embodiments, the auxiliary device 102 may use the interface 104 to allow or disallow access to media provided via the signal source input 142.

Additionally, the interface 104 may include the one or more operational indicators 114, such as LEDs, that provide operational information to facilitate troubleshooting. For example, the interface 104 may include an 8 pin RJ45 Ethernet port with a pair of LEDs, wherein the port and the LEDs are configured to provide specific status indications with regard to an operational status of the interface 104.

The commercial television 100 may include a media subsystem 148, comprising an audio subsystem 150, a display subsystem 152, or both. The audio subsystem 150 may include, for example, an audio amplifier and one or more speakers connected to the audio amplifier and may be adapted to play audio files, including audio files associated with video files being displayed by the electronic device 100. The display subsystem 152 may include, for example, a plasma display, a liquid crystal (LCD) display, a liquid-crystal-on-silicon (LCOS) display, a digital light projection (DLP) display, a cathode-ray tube display, or any other suitable display type. The display subsystem 152 may also include a lighting source (not shown) that is used to generate a visible image on the display.

An input device 154 may be used to enter user data into the commercial television 100. In an embodiment, as discussed with regard to FIG. 1, the input device 154 may include, for example, circuitry related to a keypad or buttons on the front panel 108 of the commercial television 100. Also, as discussed with respect to FIG. 1, the commercial television 100 may have a remote receiver 112 configured to receive signals from a remote control 110. The input device 154, or the remote control 110, and the media subsystem 148 together may be used in a user interface for the entry of commands for the control of the commercial television 100, the auxiliary device 102, or both. For example, the user interface may be used to instruct the commercial television 100 to play specific media files available via the auxiliary device 102. Further, the user interface may be used to display menus provided by the auxiliary device 102 on the display subsystem 152 of the commercial television 100.

A processor 156 may be configured to control the overall operation of the commercial television 100, including the decoding of digital audio or video signals transferred from the auxiliary device 102. A machine readable-medium, such as a memory 158, may be associated with the processor 156. The memory 158 may include read only memory (ROM) to hold machine-readable computer code that causes the processor 156 to control the operation of the commercial television 100. Further, the memory 158 may include random access memory (RAM) to be used for storage of temporary information, including, for example, menu information for the auxiliary device 102, such as content menus, set-up menus, and the like.

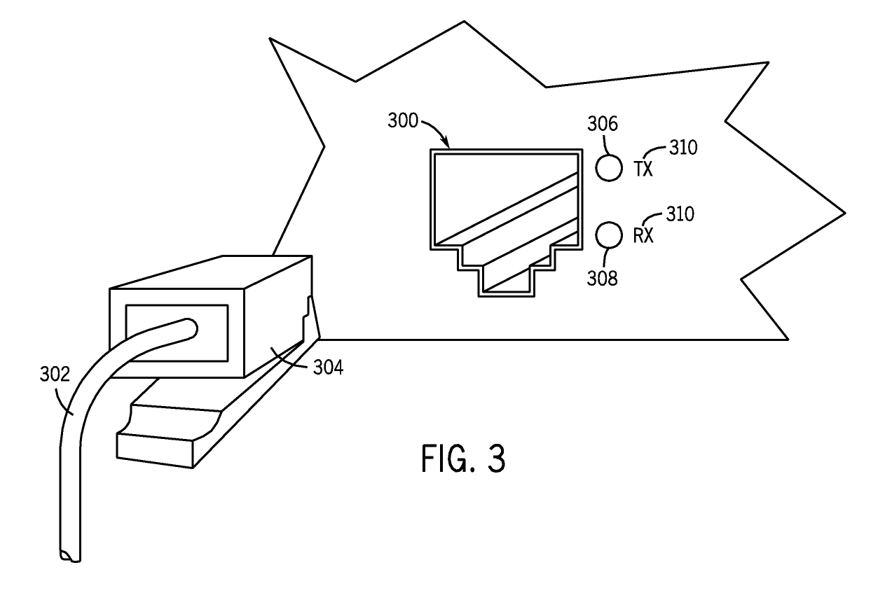

As set forth above, the commercial television 100 may be configured to facilitate communication with the auxiliary device 102 via the interface 104, which may include an interface port 300 with one or more status indicators, such as LEDs. FIG. 3 illustrates an exemplary interface port 300 (e.g., a DSCI port, a pay per view port, or a smart port) with a cable 302 and connector 304 in accordance with present embodiments. Specifically, the interface port 300 of FIG. 3 includes a first LED 306 and a second LED 308. Each of the pair of LEDs 306 and 308 may function to provide one or more indications with regard to operation of the interface port 300. Such indications may be provided as patterns of light emission. For example, the first LED 306 may indicate that power is presently being supplied to the interface port 300 when it is in a lighted state, and/or it may indicate that a transmit (TX) poll is being transmitted when it is flashing. As another example, the second LED 308 may indicate that IR is present when it is on, and/or a receive (RX) poll is being received when it is flashing. Text or some other indicator 310 may be provided near the LEDs 306 and 308 to indicate which type of information is indicated by the associated LED.

Various benefits may be obtained by employing status indicators, such as the LEDs 306 and 308, with the interface port 300. For example, providers, customers, and third-party suppliers may be able to use the LEDs 306 and 308 to troubleshoot loose connections, television setup issues, and faulty devices. Indeed, by including such indicators, present embodiments may uniquely provide certain features and capabilities. For example, one or both of the LEDs 306 and 308 may provide an indication of when a commercial television system is working properly. Additionally, as another example, one or both of the LEDs 306 and 308 may indicate an internal setup of the commercial television 100 (for example, whether baud rate is too high, whether minimum standby power is disabled, or whether IR is being accepted) and, thus, enable a service person to quickly diagnose any setup issues and/or communication issues. As yet another example, one or both of the LEDs 306 and 308 may flash certain error codes (for example, codes defined by a DSCI protocol) to indicate issues with third-party features, such as software. Further, by showing a status of an IR receive, the LEDs 308 and 308 may indicate that a wrong IR remote frequency is being used or to indicate that there is a low voltage issue. In accordance with some embodiments, to facilitate proper decoding, a carrier frequency of 56 k is used.

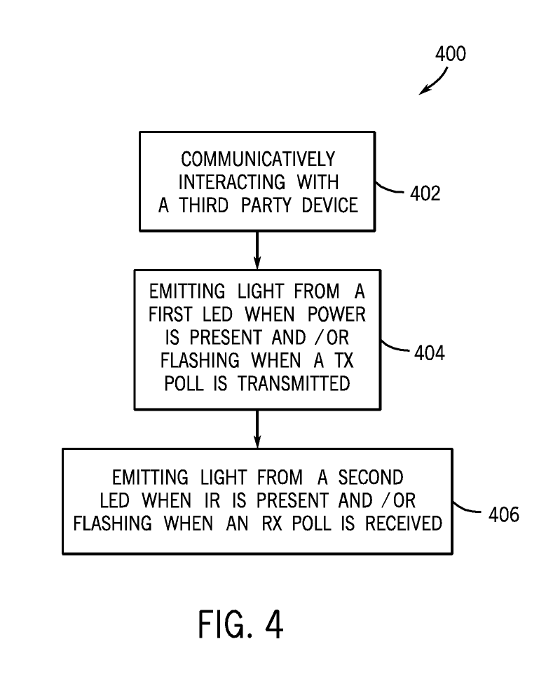

FIG. 4 is a process flow diagram illustrating a method of commercial television operation in accordance with an embodiment of the present disclosure. The method is generally indicated by reference numeral 400. The method 400 begins at block 402, which represents communicative interaction between an interface port of the television and a third-party device. Block 404 represents emitting light from a first LED when power is present to the interface port of the commercial television and/or flashing the light from the first LED when a TX poll is transmitted. Block 406 represents emitting light from a second LED when IR is present and/or flashing the light from the second LED when an RX poll is received.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A commercial television, comprising:
an interface configured to facilitate communication between the commercial television and an auxiliary device; and
an indicator configured to coordinate with the interface and provide a visual indication of a status of the interface.

2. The commercial television of claim 1, wherein the interface comprises a DSCI port, a pay per view port or a smart port and the indicator comprises an LED.

3. The commercial television of claim 1, wherein the indicator comprises an LED and the interface comprises an eight-pin RJ45 Ethernet port or a six-pin RJ25 port.

4. The commercial television of claim 1, wherein the indicator is integral with the interface.

5. The commercial television of claim 1, wherein the indicator is configured to emit light when power is present at the interface.

6. The commercial television of claim 1, wherein the indicator is configured to emit a flashing light when a transmit poll is being transmitted via the interface.

7. The commercial television of claim 1, the indicator is configured to emit a flashing light when a receive poll is being transmitted via the interface.

8. The commercial television of claim 1, wherein the indicator is configured to emit light when the interface indicates that IR is present.

9. The commercial television of claim 1, wherein the indicator comprises a first LED configured to emit light when a first condition is present at the interface, and comprising a second LED configured to emit light when a second condition is present at the interface.

10. The commercial television of claim 9, wherein the first LED and the second LED are each configured to emit light in flashing error code patterns defined by a protocol.

11. The commercial television of claim 1, wherein the indicator is one of a plurality of indicators configured to emit light in various patterns according to an operational status of the interface.

12. The commercial television of claim 11, wherein the patterns are indicative of whether the commercial television is working properly.

13. The commercial television of claim 11, wherein the patterns are indicative of an internal setup of the commercial television and/or whether a third-party feature is functioning properly.

14. A method of commercial television operation, comprising:
communicating with an auxiliary device via an interface port; and
emitting light from a plurality of LEDs in various patterns based on an operational status of the interface port as a visual indicator of the operational status.

15. The method of claim 14, comprising retaining an eight-pin RJ45 Ethernet cable or a six-pin RJ25 cable coupled to the interface port.

16. The method of claim 14, comprising emitting light from at least one of the plurality of LEDs when power is present at the interface port and flashing the light when a transmit poll is being transmitted via the interface port.

17. The method of claim 14, comprising emitting light from at least one of the plurality of LEDs when the interface port indicates that IR is present and flashing the light when a receive poll is being transmitted via the interface port.

18. The method of claim 14, wherein the patterns are indicative of whether the commercial television is working properly.

19. The method of claim 14, wherein the patterns are indicative of an internal setup of the commercial television and/or whether a third-party feature is functioning properly.

20. A system, comprising:
an auxiliary device; and
a commercial television, comprising:
an interface port configured to facilitate communication between the commercial television and the auxiliary device; and
a plurality of indicators configured to coordinate with the interface port and provide a visual indication of a status of the interface port, wherein the visual indication comprises emitting one or more patterns of light based on the status of power and/or IR availability at the interface port.
